(19) United States
(12) Patent Application Publication
(10) Pub. No.: US 2023/0405880 A1
(43) Pub. Date: Dec. 21, 2023

(54) OPTICAL PRECISION MOLD MACHINING DEVICE, A MOLDING APPARATUS WITH MOLDS, AND A MACHINING METHOD FOR USING THE MOLD MACHINING DEVICE

(71) Applicants: Cheng-Ho CHEN, Huatan Township (TW); Chih-Tsung KUO, Taichung City (TW)

(72) Inventors: Cheng-Ho Chen, Huatan Township (TW); Chih-Tsung Kuo, Taichung City (TW); Chuen-Cherng Yang, Taichung City (TW)

(73) Assignees: Cheng-Ho CHEN, Huatan Township (TW); Chih-Tsung KUO, Taichung City (TW)

(21) Appl. No.: 18/333,713

(22) Filed: Jun. 13, 2023

(30) Foreign Application Priority Data
Jun. 21, 2022 (TW) 111123093

(51) Int. Cl. B29C 33/38; G02B 3/00; B29C 45/58; B29C 45/18

(52) U.S. Cl. CPC B29C 33/3842; G02B 3/0031; B29C 45/581; B29C 45/18

(57) ABSTRACT

An optical precision mold machining device is mountable on a chuck of an ultraprecision machining apparatus to perform an aspherical molding process by a cutting tool, and includes a fixture gripped by jaws of the chuck and having positioning holes in a matrix arrangement, a plurality of fasteners extending through the corresponding positioning holes, and a mold including a retained surface with locking holes for insertion of the fasteners, and a mold surface portion having a sprue, a runner and multiple mold bases. Each mold base has sub-runners in communication with the runner. An injection direction of the sprue is parallel to an initial running direction of the runner. The mold is moved with the fixture relative to the cutting tool to a predetermined machining position where each mold base is machined to form therein a cavity with an aspherical cross-section.

### CROSS-REFERENCE TO RELATED APPLICATION

This application claims priority to Taiwanese Invention Patent Application No. 111123093, filed on Jun. 21, 2022.

### FIELD

The disclosure relates to an optical precision molding apparatus, and more particularly to an optical precision mold machining device, a molding apparatus with molds, and a machining method for using the mold machining device.

### BACKGROUND

Optical lenses generally include spherical lenses and aspherical lenses. In spherical lenses, spherical aberration will cause light rays passing through the center of the lens and light rays passing through the edge of the lens to have different focal points. However, aspherical lenses can optimally correct aberration, resulting in the light rays being focuses on a single point. Making aspherical lenses requires the use of high-precision grinding and polishing technology. Therefore, aspherical lenses are expensive to manufacture.

A conventional multi-cavity mold as disclosed in TW 201130628A includes an upper mold, a plurality of column-shaped upper cores secured in the upper mold, a lower mold and a plurality of column-shaped lower cores secured in the lower mold. Each upper core is matingly engaged with the respective lower core to form a cavity for molding a product. The upper mold has a main runner and a plurality of mounting holes surrounding the main runner for receiving the upper cores. The lower mold has a material cooling hole alignable with the main runner, a plurality of mounting holes surrounding the material cooling hole for receiving the lower cores, and a plurality of sub-runners communicating each cavity with the main runner.

Such multi-cavity mold is employed to make aspherical lenses. However, the upper cores are made separately and then assembled in the upper mold, and the lower cores are also made separately and then assembled in the lower mold. There are relatively many steps in manufacturing and assembling, which results in assembling tolerances, and difficulty in controlling the manufacturing accuracy of the lens. Specifically, in such mold, mold cavities are arranged around the main runner, which decreases the utilizable area of the mold and directly affects the production capacity of the lens.

Moreover, in a conventional mold for making lenses, an initial/feed running direction of a main runner in an upper mold is generally perpendicular to a running direction of sub-runners of a lower mold and mold cavities. Hence, a raw material injected from the main runner should flow through many turning corners, which results in pressure loss in the sub-runners and reduction of flow rate, and which might cause inconsistent degrees of crystallization in each mold cavity, and uneven crystallization strength of the lenses to result in defective products.

### SUMMARY

Therefore, an object of the disclosure is to provide an optical precision mold machining device that can alleviate at least one of the drawbacks of the prior art.

Another object of the disclosure is to provide a molding apparatus with molds that can alleviate at least one of the drawbacks of the prior art.

Still another object of the disclosure is to provide a machining method for using a mold machining device that can alleviate at least one of the drawbacks of the prior art.

According to the disclosure, the optical precision mold machining device is mountable on a chuck of an ultraprecision machining apparatus to perform an aspherical molding process by a cutting tool. The chuck has a plurality of jaws which are angularly spaced apart from each other about an axial line. The cutting tool is aligned with the axial line. The optical precision mold machining device includes a fixture, a plurality of fasteners and a mold. The fixture is gripped by the jaws of the chuck, and has a front surface, a rear surface opposite to the front surface along the axial line, and a plurality of positioning holes each extending therethrough to the front and rear surfaces in a direction of the axial line and arranged in a matrix. Each of the fasteners extends through a corresponding one of the positioning holes at a predetermined part of the fixture. The mold includes a retained surface which abuts against the front surface of the fixture, a mold surface portion which is opposite to the retained surface along the axial line, and a peripheral wall which interconnects the retained surface and the mold surface portion. The retained surface has a plurality of locking holes which extend toward the mold surface portion and which are arranged in a matrix such that the fasteners are inserted into a predetermined part of the locking holes to fasten the mold on the fixture. The mold surface portion has a sprue which extends to the peripheral wall, a runner which is in communication with and disposed downstream of the sprue, and a plurality of mold bases which project from the runner and which are arranged in a matrix. Each of the mold bases has a plurality of sub-runners which are in communication with the runner. An injection direction of the sprue is parallel to an initial running direction of the runner. The retained surface is adjustably and securely mounted to the front surface. The mold is moved with the fixture relative to the cutting tool to a predetermined machining position where each of the mold bases is machined with the cutting tool to form therein a cavity in communication with the sub-runners with an aspherical cross-section and.

According to the disclosure, the molding apparatus includes a machine base, a feeding unit, a material reflow preventing device, a pair of molds and a multi-block driving device. The feeding unit is mounted on the machine base for transporting a linear material along a direction of a longitudinal axis, and includes a plurality of feeding roller assemblies which are spaced apart from each other along the longitudinal axis, and a plurality of drive motors which are disposed to respectively drive rotation of the feeding roller assemblies. The material reflow preventing device is mounted on the machine base adjacent to the feeding unit to prevent reflow of the linear material during a feeding process. Each of the molds includes a retained surface, a mold surface portion which is opposite to the retained surface, and a peripheral wall which interconnects the retained surface and the mold surface portion. The retained surface has a plurality of locking holes which extend toward the mold surface portion and which are arranged in a matrix. The mold surface portion has a sprue which extends to the peripheral wall, a runner which is in communication with and disposed downstream of the sprue, and a plurality of mold bases which project from the runner and which are arranged in a matrix. Each of the mold bases has a plurality of sub-runners which are in communication with the runner, wherein, an injection direction of the sprue is parallel to an initial running direction of the runner. The multi-block driving device is mounted on the machine base at a side of the material reflow preventing device opposite to the feeding unit to move and lock the pair of molds to a closed state.

According to the disclosure, the machining method for using an optical precision mold machining device includes the steps of: (A) providing a molding apparatus with a chuck, a cutting tool, a fixture, a plurality of fasteners and a mold. The chuck has a plurality of jaws which are angularly spaced apart from each other about an axial line. The cutting tool is aligned with the axial line. The fixture has a front surface, a rear surface opposite to the front surface, and a plurality of positioning holes each extending therethrough to the front and rear surfaces and arranged in a matrix. Each of the fasteners extends through a corresponding one of the positioning holes at a predetermined part of the fixture. The mold includes a retained surface which abuts against the front surface of the fixture, a mold surface portion which is opposite to the retained surface, and a peripheral wall which interconnects the retained surface and the mold surface portion. The retained surface has a plurality of locking holes which extend toward the mold surface portion and which are arranged in a matrix. The mold surface portion has a sprue which extends to the peripheral wall, a runner which is in communication with and disposed downstream of the sprue, and a plurality of mold bases which project from the runner and which are arranged in a matrix. Each of the mold bases has a plurality of sub-runners which are in communication with the runner. An injection direction of the sprue is parallel to an initial running direction of the runner; (B) gripping the fixture by the jaws on the chuck; (C) mounting the mold on the fixture, wherein the retained surface abuts against the front surface of the fixture, and the fasteners are inserted into a predetermined part of the locking holes to fasten the mold on the fixture and align one of the mold bases of the mold surface portion with the cutting tool; (D) actuating the chuck to rotate the fixture and the mold, actuating the cutting tool to perform a mold machining process to a predetermined machined portion of the mold and retracting the cutting tool such that the aligned mold base is machined to form therein a cavity in communication with the sub-runners with an aspherical cross-section and; and (E) repeating step (C) and step (D) such that predetermined machined portions of the mold are machined and formed with multiple cavities with an aspherical cross-section.

### BRIEF DESCRIPTION OF THE DRAWINGS

Other features and advantages of the disclosure will become apparent in the following detailed description of the embodiment with reference to the accompanying drawings. It is noted that various features may not be drawn to scale.

FIG. 1 is a perspective view illustrating an embodiment of an optical precision mold machining device according to the disclosure.

FIG. 2 is an exploded perspective view of the embodiment.

FIG. 3 is a fragmentary perspective view illustrating a mold of the embodiment.

FIG. 4 is a sectional view of the embodiment.

FIG. 5 is a sectional view taken along line V-V of FIG. 4.

FIG. 6 is a schematic plan view of the embodiment.

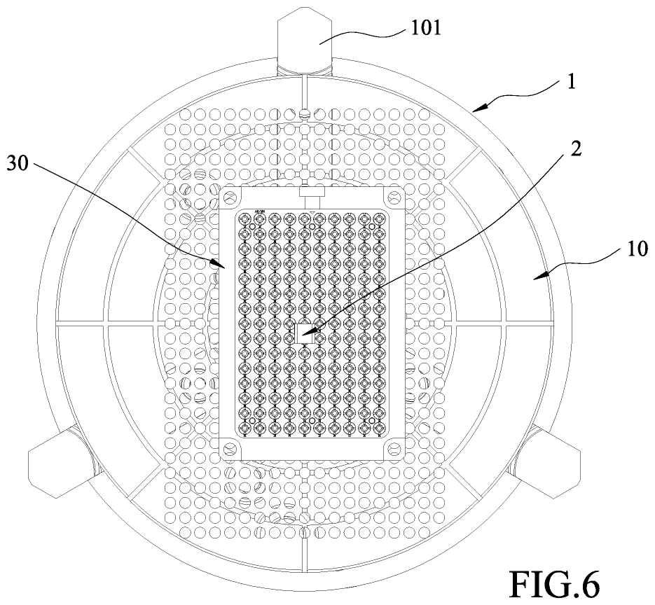

FIG. 7 is a schematic plan view of the embodiment during machining.

FIG. 8 is a schematic, partly sectional view illustrating an embodiment of a molding apparatus according to the disclosure.

FIG. 9 is a sectional view taken along line IX-IX of FIG. 8.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

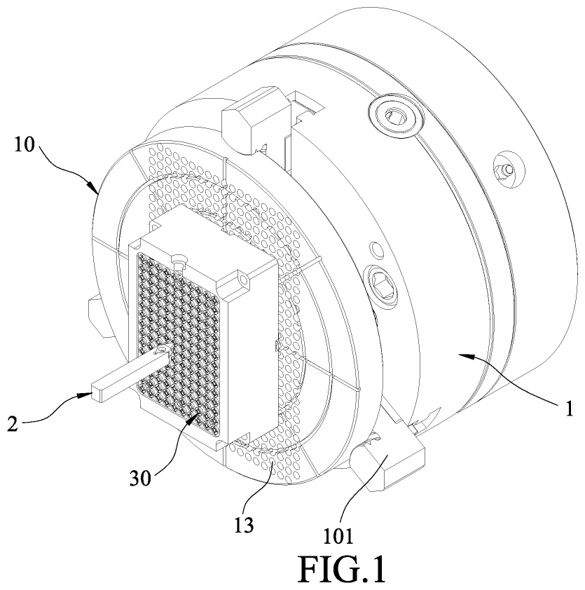

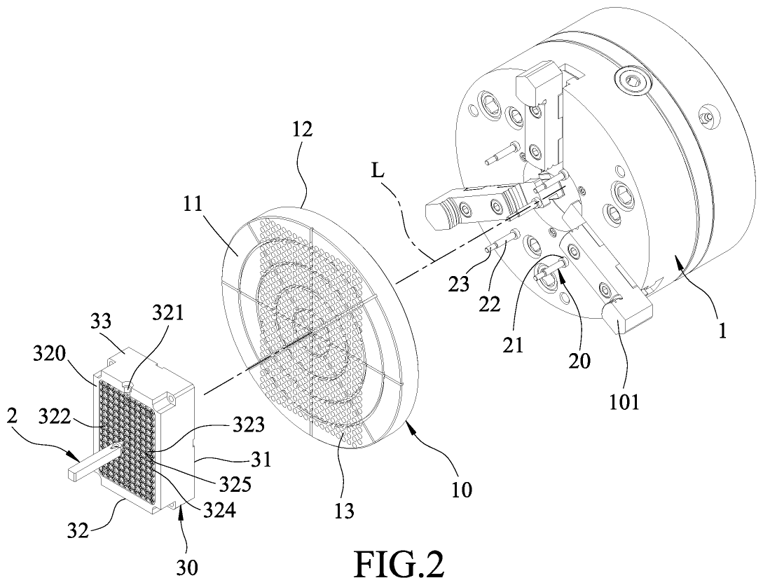

Referring to FIGS. 1 to 5 and FIG. 8, an embodiment of an optical precision mold machining device according to the disclosure is mountable on a chuck 1 of an ultraprecision machining apparatus (not shown) to perform an aspherical molding process by a cutting tool 2. The chuck 1 has a plurality of jaws 101 which are angularly spaced apart from each other about an axial line (L). The cutting tool 2 is aligned with the axial line (L). The structure of the chuck 1 and the cutting tool 2 is of a known type, and further detailed description on it will not be provided herein. The optical precision mold machining device includes a fixture 10, a plurality of fasteners 20 and a mold 30.

A molding apparatus 3 of an embodiment according to the disclosure is of an optical lens injection molding machine, and includes a machine base 40, a feeding unit 50, a material reflow preventing device 60, a plurality of multi-block driving devices 70 and a pair of the molds 30.

The fixture 10 is of a circular disc, and is gripped by the jaws 101 of the chuck 1. The fixture 10 has a front surface 11, a rear surface 12 opposite to the front surface 11 along the axial line (L), and a plurality of positioning holes 13 each extending therethrough to the front and rear surfaces 11, 12 in a direction of the axial line (L) and arranged in a matrix manner (i.e. arranged in multiple rows and columns to form a rectangular array).

The fasteners 20 are in the form of screw fasteners in the embodiment. Each fastener 20 extends through a corresponding one of the positioning holes 13 at a predetermined part of the fixture 10, and has a head 21 disposed at the rear surface 12, a shank 22 extending through the corresponding positioning hole 13, and a threading 23 projecting from the front surface 11.

The mold 30 includes a retained surface 31 which abuts against the front surface 11 of the fixture 10, a mold surface portion 32 which is opposite to the retained surface 31 along the axial line (L), and a peripheral wall 33 which interconnects the retained surface 31 and the mold surface portion 32. The retained surface 31 has a plurality of locking holes 311 which extend toward the mold surface portion 32 and which are arranged in a matrix manner. The locking holes 311 are in the form of screw holes. The fasteners 20 are inserted into a predetermined part of the locking holes 311 to fasten the mold 30 on the fixture 10. The mold surface portion 32 has a mold surface 320 to which the axial line (L) is normal, a sprue 321 which is recessed from the mold surface 320 and which extends in a direction perpendicular to the axial line (L) to the peripheral wall 33, a runner 322 which is in communication with and disposed downstream of the sprue 321, and a plurality of mold bases 323 which project from the runner 322 and which are arranged in a matrix. Each of the mold bases 323 has a plurality of sub-runners 324 which are in communication with the runner 322. An injection direction of the sprue 321 is parallel to an initial running direction (R) of the runner 322. Specifically, the runner 322 has a first end 3221 and a second end 3222 which are respectively proximate to and distal from the sprue 321 and opposite to each other in the initial running direction (R). The mold 30 is carried by and rotated with the fixture 10 relative to the cutting tool 2. Each mold base 323 is machined with the cutting tool 2 to form therein a cavity 325 in communication with the sub-runners 324 with an aspherical cross-section and.

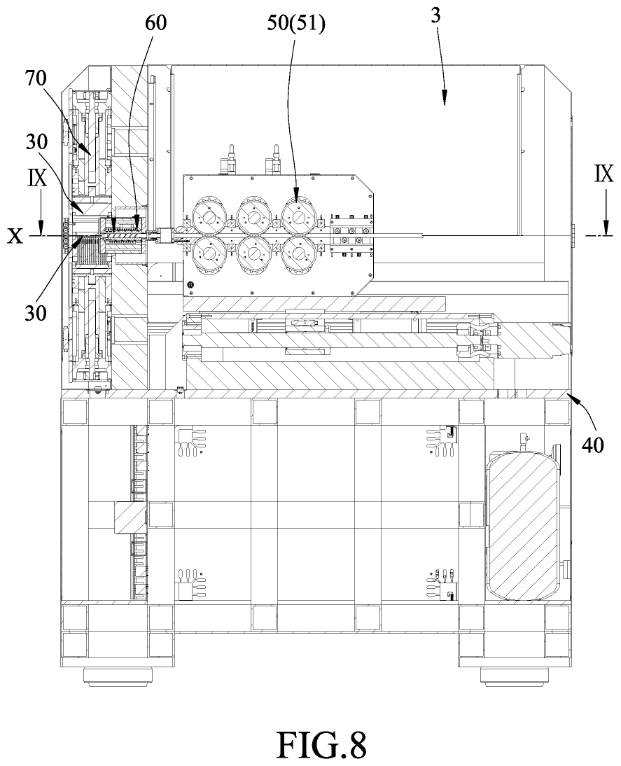

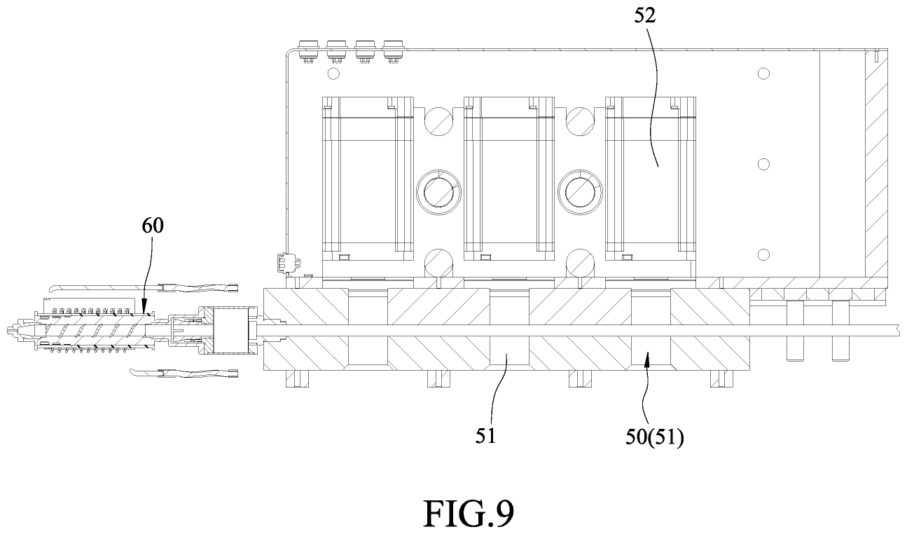

With reference to FIGS. 8 and 9, the feeding unit 50 of the molding apparatus 3 is mounted on the machine base 40 for transporting a linear material, such as a solid-state linear material, along a direction of a longitudinal axis (X), and includes a plurality of feeding roller assemblies 51 which are spaced apart from each other along the longitudinal axis (X), and a plurality of drive motors 52 which are disposed to respectively drive rotation of the feeding roller assemblies 51. The material reflow preventing device 60 is mounted on the machine base 40 adjacent to the feeding unit 50 to prevent reflow of the linear material during a feeding process. The multi-block driving device 70 is mounted on the machine base 40 at a side of the material reflow preventing device 60 opposite to the feeding unit 50 to move and lock the pair of molds 30 to a closed state. Since the structure and operation of the material reflow preventing device 60 and the multi-block driving device 70 may be a known type, further detailed description on it will not be provided herein.

An embodiment of a machining method for using an optical precision mold machining device according to the disclosure includes the following steps.

(A) Providing a molding apparatus with the chuck 1, the cutting tool 2, the fixture 10, the fasteners 20 and the mold 30.

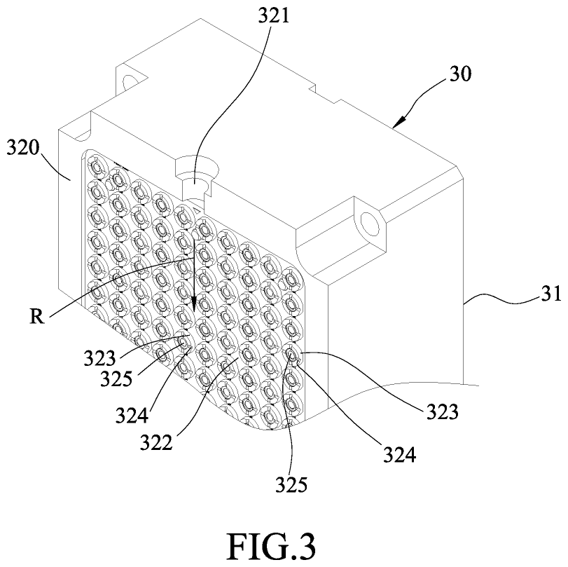

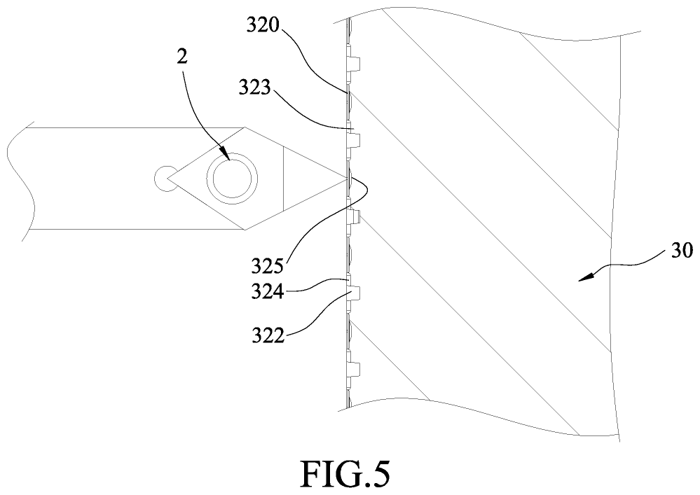

(B) Referring to FIGS. 3 and 5, gripping the fixture 10 by the jaws 101 on the chuck 1 to coaxially mount the fixture 10 on the chuck 1.

(C) Mounting the mold 30 on the fixture 10. The retained surface 31 abuts against the front surface 11 of the fixture 10, and the fasteners 20 are inserted into a predetermined part of the locking holes 311 to firmly fasten the mold 30 on the fixture 10 and align one of the mold bases 323 of the mold surface portion 32 with the cutting tool 2.

(D) Actuating the chuck 1 to rotate the fixture 10 and the mold 30 relative to the cutting tool 2. Then, actuating the cutting tool 2 to perform a mold machining process to the aligned mold base 323 of the mold 30 and retracting the cutting tool 2 (the cutting tool 2 is angularly deflected during the mold machining process) such that the aligned mold base 323 is machined to form therein a cavity 325 in communication with the sub-runners 324 with an aspherical cross-section.

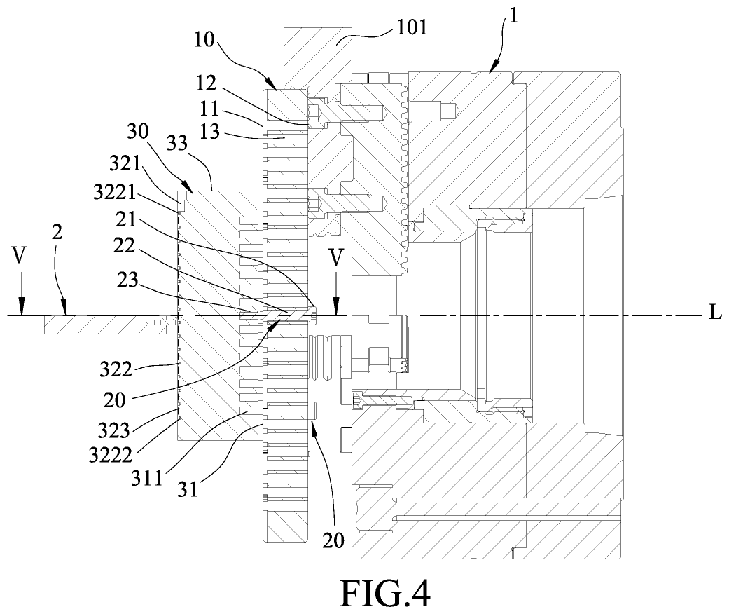

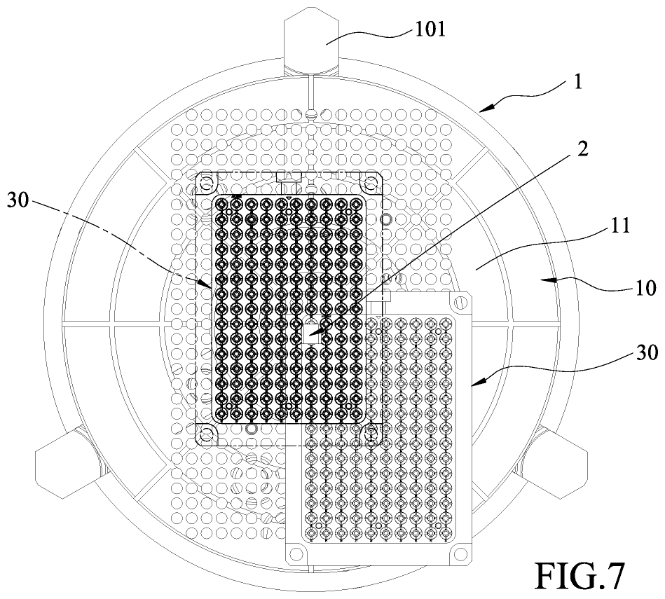

(E) Referring to FIGS. 4 and 7, repeating step (C) and step (D). The retained surface 31 of the mold 30 is adjustably and securely mounted to the front surface 11 such that a variety of the mold bases 323 at predetermined machined portions of the mold 30 are machined and formed with multiple cavities 325 with an aspherical cross-section. The multiple cavities 325 of the mold 30 are arranged in a matrix. To adjust the mold 30 with a predetermined machined portion aligned with the cutting tool 2, the fasteners 20 are disengaged from the locking holes 311 of the mold and the positioning holes 13 of the fixture 10, and the mold 30 is adjusted to a predetermined machining position relative to the fixture 10. Subsequently, the fasteners 20 extend through the positioning holes 13 of the fixture 10 and threadedly engaged with the corresponding locking holes 311 of the mold 30. One of the fasteners is aligned with the axial line (L), and the other fasteners 20 are equidistantly arranged relative to the axial line (L) to firmly fasten the mold 30 on the fixture 10. As indicated by the dotted line in FIG. 7, another mold base 323 of the adjusted mold 30 is aligned with the cutting tool 2, and the center of the mold 30 is not aligned with the axial line (L).

Through the above-mentioned sequence of steps, and with the control of a predetermined program, the cavities 325 with aspherical cross-sections can be sequentially machined and formed in the mold surface portion 32 of the mold 30. The cavities 325 of the mold 30 are arranged in a matrix. Thus, with the mold 30, through an injection molding process, multiple aspherical lenses can be manufactured simultaneously, which can simplify the manufacturing and assembly process, minimize assembly tolerances, and allow the manufacturing accuracy of the lenses easily controllable. Specifically, because the mold surface portion 32 of the mold 30 has the sprue 321 that is in communication with the cavities 325 through the runner 322 and the sub-runners 324 and that extends to the peripheral wall 33, and the cavities 325 are arranged in the matrix, the area of the mold 30 has a great utilization rate, which increases the production capacity of the lenses.

To perform an injection molding process, the pair of molds 30 are driven by the multi-block driving device 70 to be moved and locked to the closed state. Through the feeding unit 50, the solid-state linear material is pressed toward the material reflow preventing device 60 and is molten into a fluid-state material, and the fluid-state material is injected into the molds 30.

Further, during the injection molding process, with the injection direction of the sprue 321 being parallel to an initial running direction (R) of the runner 322, the material is injected from the sprue 321 and flows into the cavities 325 without passing corners so as to minimize pressure loss, and prevent reduction of flow rate and cause consistent crystallization in each cavity 325, and even crystallization strength of the lenses.

As illustrated, the optical precision mold machining device and the molding apparatus according to the disclosure have a simple structure that is easy to fabricate at a relatively low manufacturing cost.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An optical precision mold machining device mountable on a chuck of an ultraprecision machining apparatus to perform an aspherical molding process by a cutting tool, the chuck having a plurality of jaws which are angularly spaced apart from each other about an axial line, the cutting tool being aligned with the axial line, said optical precision mold machining device comprising:
a fixture gripped by the jaws of the chuck, and having a front surface, a rear surface opposite to said front surface along the axial line, and a plurality of positioning holes each extending therethrough to said front and rear surfaces in a direction of the axial line and arranged in a matrix;
a plurality of fasteners each extending through a corresponding one of said positioning holes at a predetermined part of said fixture; and
a mold including a retained surface which abuts against said front surface of said fixture, a mold surface portion which is opposite to said retained surface along the axial line, and a peripheral wall which interconnects said retained surface and said mold surface portion, said retained surface having a plurality of locking holes which extend toward said mold surface portion and which are arranged in a matrix such that said fasteners are inserted into a predetermined part of said locking holes to fasten said mold on said fixture, said mold surface portion having a sprue which extends to said peripheral wall, a runner which is in communication with and disposed downstream of said sprue, and a plurality of mold bases which project from said runner and which are arranged in a matrix, each of said mold bases having a plurality of sub-runners which are in communication with said runner, wherein, an injection direction of said sprue being parallel to an initial running direction of said runner, said retained surface being adjustably and securely mounted to said front surface, said mold being moved with said fixture relative to the cutting tool to a predetermined machining position where each of said mold bases is machined with the cutting tool to form therein a cavity in communication with said sub-runners with an aspherical cross-section and.

2. A molding apparatus comprising:
a machine base;
a feeding unit mounted on said machine base for transporting a linear material along a direction of a longitudinal axis, and including a plurality of feeding roller assemblies which are spaced apart from each other along the longitudinal axis, and a plurality of drive motors which are disposed to respectively drive rotation of said feeding roller assemblies;
a material reflow preventing device mounted on said machine base adjacent to said feeding unit to prevent reflow of the linear material during a feeding process;
a pair of molds, each including a retained surface, a mold surface portion which is opposite to said retained surface, and a peripheral wall which interconnects said retained surface and said mold surface portion, said retained surface having a plurality of locking holes which extend toward said mold surface portion and which are arranged in a matrix, said mold surface portion having a sprue which extends to said peripheral wall, a runner which is in communication with and disposed downstream of said sprue, and a plurality of mold bases which project from said runner and which are arranged in a matrix, each of said mold bases having a plurality of sub-runners which are in communication with said runner, wherein, an injection direction of said sprue being parallel to an initial running direction of said runner; and
a multi-block driving device mounted on said machine base at a side of said material reflow preventing device opposite to said feeding unit to move and lock said pair of molds to a closed state.

3. A machining method for using an optical precision mold machining device, comprising:
(A) providing a molding apparatus with a chuck, a cutting tool, a fixture, a plurality of fasteners and a mold, the chuck having a plurality of jaws which are angularly spaced apart from each other about an axial line, the cutting tool being aligned with the axial line, the fixture having a front surface, a rear surface opposite to said front surface, and a plurality of positioning holes each extending therethrough to said front and rear surfaces and arranged in a matrix, the plurality of fasteners each extending through a corresponding one of the positioning holes at a predetermined part of the fixture, the mold including a retained surface which abuts against the front surface of the fixture, a mold surface portion which is opposite to said retained surface, and a peripheral wall which interconnects the retained surface and the mold surface portion, the retained surface having a plurality of locking holes which extend toward the mold surface portion and which are arranged in a matrix, the mold surface portion having a sprue which extends to the peripheral wall, a runner which is in communication with and disposed downstream of the sprue, and a plurality of mold bases which project from the runner and which are arranged in a matrix, each of the mold bases having a plurality of sub-runners which are in communication with the runner, an injection direction of the sprue being parallel to an initial/feed running direction of the runner;
(B) gripping the fixture by the jaws on the chuck;
(C) mounting the mold on the fixture, wherein the retained surface abuts against the front surface of the fixture, and the fasteners are inserted into a predetermined part of the locking holes to fasten the mold on the fixture and align one of the mold bases of the mold surface portion with the cutting tool;
(D) actuating the chuck to rotate the fixture and the mold, actuating the cutting tool to perform a mold machining process to a predetermined machined portion of the mold and retracting the cutting tool such that the aligned mold base is machined to form therein a cavity in communication with the sub-runners with an aspherical cross-section and; and
(E) repeating step (C) and step (D) such that predetermined machined portions of the mold are machined and formed with multiple cavities with an aspherical cross-section.
